(19) United States
(12) Patent Application Publication
(10) Pub. No.: US 2008/0219526 A1
(43) Pub. Date: Sep. 11, 2008

(54) System and Method for Volume Rendering Three-Dimensional Ultrasound Perfusion Images

(75) Inventor: George A. Brock-Fisher, Andover, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/908,228

(22) PCT Filed: Mar. 2, 2006
(86) PCT No.: PCT/IB2006/050657

§ 371 Date: Sep. 10, 2007

Related U.S. Application Data
(60) Provisional application No. 60/660,657, filed on Mar. 11, 2005.

(51) Int. Cl. G06T 11/00

(52) U.S. Cl. 382/128

(57) ABSTRACT

A three-dimensional visualization technique for easily identifying common morphological landmarks in volume rendered ultrasound perfusion images. The technique includes processing acoustic data received by an ultrasound imaging system (100) according to at least two different signal processing methods. One of these methods is perfusion-specific, while another of these methods is tissue-specific. Each of these methods provides separately processed volume images. A volume rendering step (14, 16) assigns different volume rendering characteristics to each of the volume images according to whether the volume images are based on perfusion- or tissue-specific acoustic data. The at least two volume images can also be differentiated in the volume rendering step by assigning each volume image a specific color. The volume images are finally combined (18) and displayed (20).

The present disclosure relates generally to ultrasound imaging. More particularly, the present disclosure relates to a system and method for volume rendering three-dimensional ultrasound perfusion images.

In the field of ultrasound imaging, there are numerous detection techniques specifically optimized for the detection of ultrasound contrast agents (UCAs). Several of these techniques include pulse inversion, power modulation, ultraharmonics, etc. The goal of these ultrasound detection techniques is to provide an imaging detection mode that is specifically sensitive to UCAs, while suppressing sensitivity to tissue and blood present in the ultrasound field. The primary use of these detection techniques is to visualize UCAs while being used as a blood marker in cardiac perfusion studies as a means of assessing coronary artery disease.

In a normal (non-contrast specific) ultrasound image, tissues are depicted as bright structures, and blood pools such as the ventricles of the heart are depicted as dark or black areas.

In a perfusion ultrasound image, due to the large concentration of UCA in the blood, the ventricles of the heart are depicted as bright areas, while the perfused myocardium is depicted as a mid-level gray. This results in a lower overall contrast level distinction in the image between the ventricles (chambers) of the heart and the surrounding tissues.

Another contemporary technology in the field of ultrasound imaging is three-dimensional ultrasound imaging. Typically, a matrix array of transducer elements is used to transmit ultrasound waves and receive acoustic data in three dimensions. The acoustic data is rendered as known in the art to form a three-dimensional image, such as a three-dimensional image of the structures of the heart. A volume rendering technique is used where the tissues are visualized as partially transparent, allowing the visualization of structures distal to the transducer.

However, when presenting a three-dimensional rendered image of a perfusion specific ultrasound image where the patient has been administered a contrast agent, the lower visual contrast levels in the volume rendered image make it particularly difficult to identify common morphological landmarks. Accordingly, there exists a need for an improved three-dimensional visualization technique for easily identifying common morphological landmarks in volume rendered ultrasound perfusion images. There also exists a need for a system for performing the three-dimensional visualization technique.

The present disclosure provides a system and method for volume rendering three-dimensional ultrasound perfusion images. In particular, the present disclosure provides an improved three-dimensional visualization technique for easily identifying common morphological landmarks in volume rendered ultrasound perfusion images. The present disclosure also provides a system for performing the three-dimensional visualization technique.

The three-dimensional visualization technique in accordance with the present disclosure includes processing acoustic data received by an ultrasound imaging system according to at least two different signal processing methods. One of these methods is perfusion-specific, while another of these methods is tissue-specific. Each of these methods provides separately processed volume images.

A volume rendering step assigns different volume rendering characteristics to each of the volume images according to whether the volume images are based on perfusion- or tissue-specific acoustic data. The at least two volume images can also be differentiated in the volume rendering step by assigning each volume image a specific color. For example, the perfusion volume image can be represented in different intensities of an orange color, while the tissue volume image can be represented as varying intensities of a green color. The volume images are finally combined to form a combined image. Accordingly, in accordance with the method of the present disclosure, the tissue landmarks are more clearly recognizable by the user, thereby providing an improved visualization of position and orientation of the overall image, while still maintaining the desired perfusion information.

Various embodiments of the present disclosure will be described herein below with reference to the figures wherein:

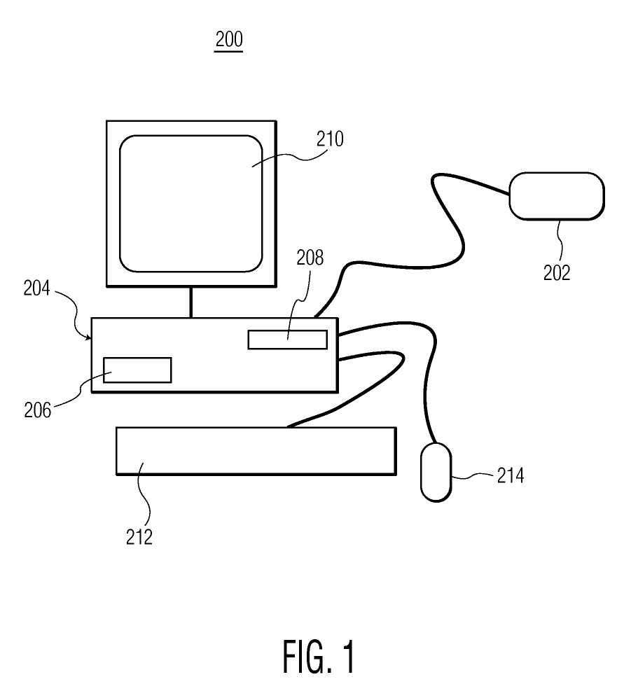

FIG. 1 is an ultrasound imaging system in accordance with the present disclosure capable of performing the method of the present disclosure; and

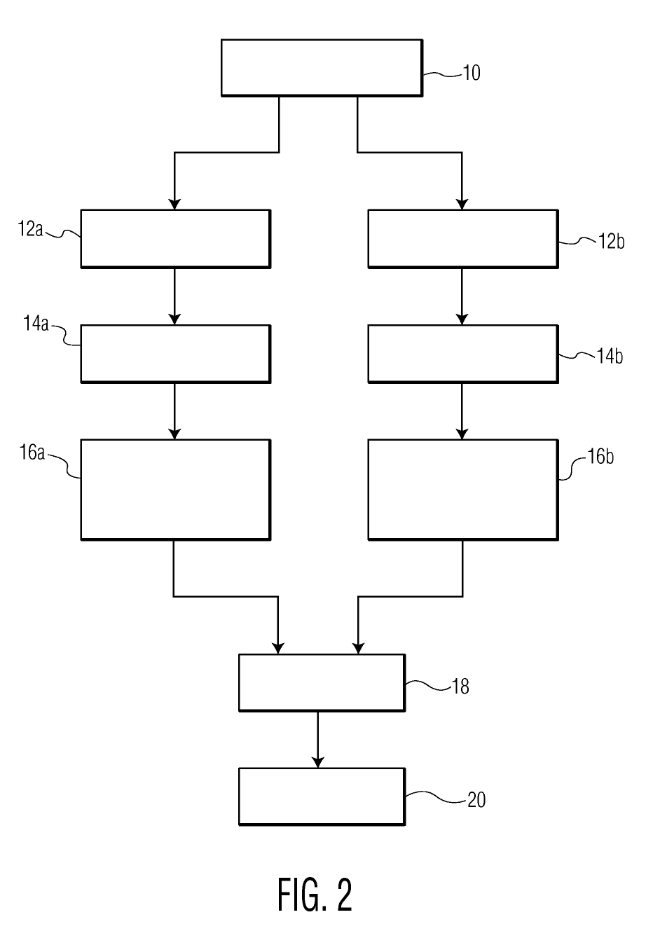

FIG. 2 is a flowchart illustrating the steps of the method in accordance with the present disclosure.

The present disclosure provides a system and method for volume rendering three-dimensional ultrasound perfusion images. In particular, the present disclosure provides an improved three-dimensional visualization technique for easily identifying common morphological landmarks in volume rendered ultrasound perfusion images. The present disclosure also provides an ultrasound imaging system for performing the three-dimensional visualization technique illustrated by the flow chart shown by FIG. 2. The ultrasound imaging system for performing the three-dimensional visualization technique of the present disclosure is illustrated by FIG. 1; the system is designated generally by reference numeral 200.

The system 200 includes an ultrasound transducer assembly 202 connected to an imaging workstation 204. The imaging workstation 204 contains at least one processor 106 and at least one storage device 208, such as a hard drive, RAM disk, etc. The storage device(s) 108 may be used for temporary and long term storage of image data acquired by the ultrasound transducer 202. The ultrasound imaging system 200 also provides a video display 210 and user input devices, including a keyboard 212 and a mouse 214. The at least one processor 206 is configured to execute a set of programmable instructions for performing the three-dimensional visualization technique in accordance with the present disclosure.

The three-dimensional visualization technique in accordance with the present disclosure is illustrated by the flow chart shown by FIG. 2. In step 10, an original acoustic volume data set is received or acquired by the ultrasound imaging system 200 and processed according to at least two different signal processing methods in steps 12a and 12b. One of these methods is perfusion-specific, while another of these methods is tissue-specific. Ideally, the tissue-specific method would present the lowest possible sensitivity to contrast agent. Note that the separate signal processing could be applied to a single acoustic data set. The perfusion-specific method provides a perfusion data set and the tissue-specific method provides a tissue data set.

In steps 14 and 16, the perfusion and tissue data sets are volume rendered to generate volume images. Volume rendering on tissue data has been contemporarily rendered as varying intensities of a monochrome image (which could be black and white or varying intensities of a more or less constant hue). First, the volume rendering steps 12a and 12b convert the acoustic data set which is acquired in an R-elevation-azimuth polar format into a two-dimensional display which serves to provide three-dimensional visualization cues to the observer.

The at least two volume images can also be differentiated in the volume rendering step 12 by assigning each volume image a specific color. For example, the perfusion volume image can be represented in different intensities of an orange color, while the tissue volume image can be represented as varying intensities of a green color.

Second, in steps 16a and 16b, different volume rendering characteristics; principally color, but could also include different characteristics of opacity, contrast, texture, or other commonly used characteristics of volume rendering already known in the art, are assigned to each of the volume images according to whether the volume images are based on a perfusion- or tissue-specific acoustic data set as determined by the at least one processor 206.

The separately processed volume images or volume rendered acoustic data sets are combined in step 18 to form a combined image. In step 20, the volume rendered acoustic data sets are displayed to the user or an observer. Accordingly, in accordance with the method of the present disclosure, the tissue landmarks are more clearly recognizable by the user, thereby providing an improved visualization of position and orientation of the overall image, while still maintaining the desired perfusion information.

As stated above, the three-dimensional visualization technique of the present disclosure is performed by the system 200 of the present disclosure by having the at least one processor 206 of the system 200 execute the set of programmable instructions. It is contemplated that the set of programmable instructions can be stored within the at least one storage device 208 and/or on a computer-readable medium, such as a CD, 3.5″ diskette, hard drive, etc., and capable of being executed by the at least one processor 206.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

1. A method for improved visualization of common morphological landmarks in volume rendered images, said method comprising the steps of:
processing received acoustic data according to at least two different signal processing methods, wherein each of the at least two different signal processing methods provides separately processed volume images;
volume rendering the volume images comprising the step of assigning different volume rendering characteristics to each of the volume images according to the differently processed acoustic data; and
combining the volume rendered images to form a combined image, wherein there is improved visualization of common morphological landmarks in the volume rendered images.

2. The method according to claim 1, wherein one method of the at least two different signal processing methods is perfusion-specific and another method of the at least two different signal processing methods is tissue-specific.

3. The method according to claim 1, wherein the two different signal processing methods are performed on a single original set of acoustic data.

4. The method according to claim 1, wherein the volume rendering step further comprises the step of varying intensities of a monochrome image.

5. The method according to claim 1, wherein the volume rendering step further comprises the step of differentiating the volume images by assigning each volume image a specific color.

6. The method according to claim 1, wherein the method is performed by an ultrasound imaging system (200).

7. A system (200) for identifying common morphological landmarks in volume rendered images, said system comprising:
means for processing received acoustic data according to at least two different signal processing methods, wherein each of the at least two different signal processing methods provides separately processed volume images;
means for volume rendering the volume images comprising means for assigning different volume rendering characteristics to each of the volume images of the combined image according to the differently processed acoustic data; and
means for combining the separately processed volume images to form a combined image for identifying common morphological landmarks in the volume rendered images.

8. The system (200) according to claim 7, wherein one method of the at least two different signal processing methods is perfusion-specific and another method of the at least two different signal processing methods is tissue-specific.

9. The system (200) according to claim 7, wherein one method of the at least two different signal processing methods is perfusion-specific and another method of the at least two different signal processing methods is tissue-specific.

10. The system (200) according to claim 7, wherein the means for volume rendering further comprises means for varying intensities of a monochrome image.

11. The system (200) according to claim 7, wherein the means for volume rendering further comprises means for differentiating the volume images by assigning each volume image a specific color.

12. A computer readable medium storing a set of programmable instructions for being executed by at least one processor (206) for performing a method for identifying common morphological landmarks in volume rendered images comprising the steps of:
processing received acoustic data according to at least two different signal processing methods, wherein each of the at least two different signal processing methods provides separately processed volume images; and
volume rendering the volume images comprising the step of assigning different volume rendering characteristics to each of the volume images according to the differently processed acoustic data; and
combining the volume rendered images to form a combined image, wherein there is improved visualization of common morphological landmarks in the volume rendered images.

13. The computer readable medium according to claim 12, wherein one method of the at least two different signal processing methods is perfusion-specific and another method of the at least two different signal processing methods is tissue-specific.

14. The computer readable medium according to claim 12, wherein the volume rendering step further comprises the step of varying intensities of a monochrome image.

15. The computer readable medium according to claim 12, wherein the volume rendering step further comprises the step of differentiating the volume images by assigning each volume image a specific color.

16. The computer readable medium according to claim 12, wherein the at least one processor (206) is within an ultrasound imaging system (200).
